(19) United States
(12) Patent Application Publication
(10) Pub. No.: US 2006/0093897 A1
(43) Pub. Date: May 4, 2006

(54) Pouch type lithium rechargeable battery

(76) Inventors: Jae-Hoon Choi, Youngin-si (KR); Young-Bae Sohn, Youngin-si (KR); Kyung-Won Seo, Youngin-si (KR)

Correspondence Address: H.C. PARK & ASSOCIATES, PLC, 8500 LEESBURG PIKE, SUITE 7500, VIENNA, VA, 22182, US

(21) Appl. No.: 11/230,536

(22) Filed: Sep. 21, 2005

(30) Foreign Application Priority Data
Sep. 22, 2004 (KR) 10-2004-0076149

(51) Int. Cl. H01M 10/50; H01M 2/02; H01M 2/26

(52) U.S. Cl. 429/62; 429/162; 429/176; 429/181; 429/161

(57) ABSTRACT

A pouch type lithium rechargeable battery with improved stability comprises an electrode assembly including a first electrode plate, a second electrode plate, and a separator interposed between the first electrode plate and the second electrode plate, a pouch case having a cavity for housing the electrode assembly therein, a protective circuit module for controlling charge/discharge of the electrode assembly, and a connection lead that couples the protective circuit module with the electrode assembly while shutting off a current being applied to the electrode assembly when a temperature of the electrode assembly rises abnormally.

### CROSS REFERENCE TO RELATED APPLICATION

This application claims priority to and the benefit of Korean Patent Application No. 10-2004-0076149, filed on Sep. 22, 2004, which is hereby incorporated by reference for all purposes as if fully set forth herein.

### BACKGROUND OF THE INVENTION

1. Field of the Invention

The present invention relates to a lithium rechargeable battery and a connection lead structure for coupling an electrode assembly with a protective circuit module.

2. Description of the Background

Recently, compact lightweight electronic devices such as cellular phones, notebook computers and camcorders have been actively developed. Such electronic devices are equipped with battery packs so that the devices may be portable. The battery packs include at least one bare cell that is capable of supplying an operating voltage to the electronic devices for a predetermined duration.

Rechargeable batteries are currently used in the battery pack due to their economic advantages. The rechargeable batteries may include Ni—Cd batteries, Ni-MH batteries, and Li rechargeable batteries such as Li batteries or Li-ion batteries.

In particular, lithium rechargeable batteries have an operating voltage of about 3.6 V, which is three times higher than that of Ni—Cd batteries or Ni-MH batteries. In addition, the lithium ion rechargeable batteries have a high energy density per unit weight, so they are extensively used in the advanced electronic technologies.

The lithium rechargeable battery uses a lithium-based oxide as a positive electrode active material and carbon as a negative electrode active material. In general, lithium batteries are classified into categories including liquid electrolyte batteries and polymer electrolyte batteries based on the kind of electrolytes used. Liquid electrolyte batteries are called “lithium ion batteries” and polymer electrolyte batteries are called “lithium polymer batteries.” In addition, lithium rechargeable batteries may be fabricated in various shapes such as cylindrical lithium rechargeable batteries, rectangular-box lithium rechargeable batteries, or pouch type lithium rechargeable batteries.

The pouch type lithium rechargeable battery includes a pouch case comprising a metal foil layer and a synthetic resin layer that covers the metal foil layer. Thus, the weight of the pouch type lithium rechargeable battery may be significantly reduced compared to that of the cylindrical lithium rechargeable battery or the rectangular-box lithium rechargeable battery that uses a metal can.

A pouch type lithium rechargeable battery includes a pouch case in which an electrode assembly including a positive electrode plate, a negative electrode plate, and a separator interposed between the positive electrode plate and negative electrode plate. In addition, a positive electrode tab and a negative electrode tab protrude out of the pouch case and are coupled with a protective circuit module (PCM).

In general, the PCM includes a printed circuit board (PCB) on which various protective circuits and a positive thermal coefficient (PTC) device are provided.

However, if the electrode assembly malfunctions, heat generated from the electrode assembly may be applied to the PTC device of the PCM through an electrode tab and a connection lead. This may reduce the reaction speed of the PTC device and subject the lithium rechargeable battery to a dangerous explosion.

### SUMMARY OF THE INVENTION

The present invention provides a pouch type lithium rechargeable battery that includes a device that shuts off a current in the battery by rapidly detecting abnormal heat when such heat is generated from the electrode assembly due to a malfunction of the electrode assembly.

The present invention also provides a pouch type lithium rechargeable battery that shuts off an electric connection in the battery by rapidly detecting abnormal heat when it is generated in an electrode assembly, thereby increasing the battery's stability.

Additional features of the invention will be set forth in the description which follows, and in part will be apparent from the description, or may be learned by practice of the invention.

The present invention discloses a pouch type lithium rechargeable battery comprising an electrode assembly including a first electrode plate, a second electrode plate, and a Is separator interposed between the first electrode plate and the second electrode plate. The battery further comprises a pouch case that includes a cavity for accommodating the electrode assembly therein, a protective circuit module for controlling charge/discharge of the electrode assembly, and a connection lead that couples the protective circuit module with the electrode assembly while shutting off a current in the pouch type lithium rechargeable battery when the temperature of the battery rises abnormally.

The present invention also discloses a pouch type lithium rechargeable battery comprising an electrode assembly including a first electrode plate, a second electrode plate, and a separator interposed between the first electrode plate and second electrode plate. The battery further comprises a pouch case that includes a cavity for accommodating the electrode assembly therein, a protective circuit module for controlling charge/discharge of the electrode assembly, and a connection lead that couples the protective circuit module with the electrode assembly and functions as a positive thermal coefficient device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a perspective view of a pouch type lithium rechargeable battery when a pouch case is opened according to an exemplary embodiment of the present invention.

FIG. 1B is a perspective view of a pouch type lithium rechargeable battery when a pouch case has been sealed according to an exemplary embodiment of the present invention.

FIG. 2A is an exploded perspective view of a structure of a connection lead of a pouch type lithium rechargeable battery according to an exemplary embodiment of the present invention.

FIG. 2B is a sectional view of a structure of a connection lead of a pouch type lithium rechargeable battery according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

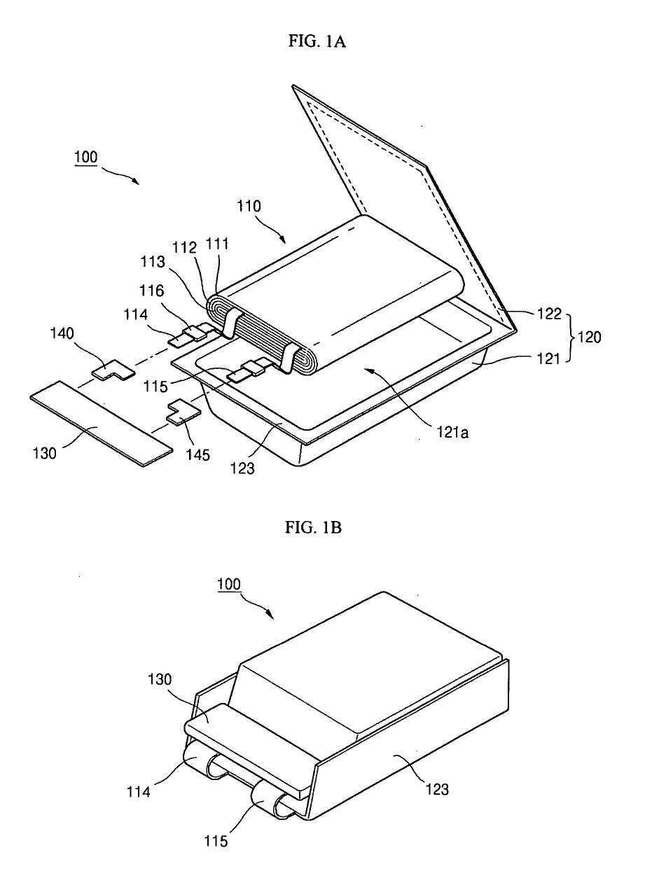

FIG. 1A is a perspective view of a pouch type lithium rechargeable battery when a pouch case is opened according to an exemplary embodiment of the present invention. FIG. 1B is a perspective view of the pouch type lithium rechargeable battery when the pouch case has been sealed according to an exemplary embodiment of the present invention.

Referring to FIG. 1A and FIG. 1B, the pouch type lithium rechargeable battery 100 includes an electrode assembly 110, a pouch case 120 that houses the electrode assembly 110 therein, a protective circuit module 130 that controls the charge/discharge of the electrode assembly 110, and connection leads 140 and 145 that couple the electrode assembly 110 to the protective circuit module 130 while serving as positive thermal coefficient devices.

The electrode assembly 110 includes a first electrode plate 111 coated with either a positive active material or a negative active material (preferably, positive active materials), a second electrode plate 112 coated with either a positive active material and a negative active material (preferably, the negative active material), and a separator 113 interposed between the first electrode plate 111 and the second electrode plate 112 in order to prevent a short circuit between the first electrode plate 111 and a second electrode plate 112 while allowing the movement of lithium ions, exclusively.

In addition, a first electrode tab 114 comprising Al is coupled with the first electrode plate 111. The first electrode tab 114 protrudes upward from the first electrode plate 111 by a predetermined distance and serves as a positive electrode tab. A second electrode tab 115 comprising Ni is coupled with the second electrode plate 112. The second electrode tab 115 protrudes downward from the second electrode plate 112 by a predetermined distance and serves as a negative electrode tab. Although the first electrode tab 114 and the second electrode tab 115 may comprise Al and Ni, respectively, the present invention composition of the electrode tabs are not limited thereto. In addition, an insulation tab 116 may be provided to prevent a short circuit between the pouch case 120 and the first electrode tab 114 and the second electrode tab 115.

The positive active material may include chalcogenide compounds. For instance, the positive active material may include, but is not limited to composite metal oxides such as LiCoO₂, LiMn₂O₄, LiNiO₂, LiNi₁₋ₓCoₓO₂ (0<x<1), or LiCoO₂. The negative active material may include, but is not limited to carbon-based materials, Si, Sn, tin oxides, composite tin alloys, transition metal oxides, lithium metal nitrides or lithium metal oxides. In general, the positive electrode plate may comprise Al and the negative electrode plate may comprise Cu. In addition, the separator may comprise polyethylene (PE) or polypropylene (PP). However, the present invention is not limited thereto.

The pouch case 120 includes a lower part 121 having a cavity 121a for housing the electrode assembly 110 therein, and an upper part 122 for covering the lower part 121 having the cavity 121a. An edge portion of the lower part 121 formed around the cavity 121a may serve as a bonding part 123 when the electrode assembly 110 has been accommodated in the cavity 121a. In addition, the cavity 121a may be formed with a press. The pouch case 120 is sealed by bonding the upper part 122 to the lower part 121 after the electrode assembly 110 has been accommodated in the cavity 121a.

The first electrode tab 114 and the second electrode tab 115 of the electrode assembly 110 protrude out of the pouch case 120 through predetermined portions of the bonding part 123 of the pouch case 120. The first electrode tab 114 and the second electrode tab 115 are coupled with the protective circuit module 130 through the first connection lead 140 and the second connection lead 145, respectively.

The protective circuit module 130 is provided to control the charge/discharge of the electrode assembly 110 while preventing malfunction of the electrode assembly 110. For instance, when the electrode assembly 110 is subject to an over-current, the protective circuit module 130 shuts off the over-current. Although they are not illustrated in figures, various other protective circuits may also be provided on the protective circuit module 130.

The first connection lead 140 and the second connection lead 145 couple the first electrode tab 114 and the second electrode tab 115 with the protective circuit module 130, respectively. At least one of the first connection lead 140 and the second connection lead 145 may serve as the positive thermal coefficient device. For example, the second connection lead 145 that is coupled with the second electrode tab 115 (the negative electrode tab) may serve as the positive thermal coefficient device.

First ends of the first connection lead 140 and the second connection lead 145 may be coupled with end portions of the first electrode tab 114 and the second electrode tab 115, respectively. In addition, second ends of the first connection lead 140 and the second connection lead 145 may be coupled with the protective circuit module 130 so that the first electrode tab 114 and the second electrode tab 115 are coupled with the protective circuit module 130, respectively. The first connection lead 140 and the second connection lead 145 may have L-shapes, but the present invention is not limited thereto.

In addition, as shown in FIG. 1B, after the first electrode tab 114 and the second electrode tab 115 have been coupled with the protective circuit module 130 through the first connection lead 140 and the second connection lead 145, respectively, the first electrode tab 114 and the second electrode tab 115 and the first connection lead 140 and the second connection lead 145 may be folded so that the protective circuit module 130 may be positioned above exposed parts of the first electrode tab 114 and the second electrode tab 115 on the bonding part 123 of the pouch case 120.

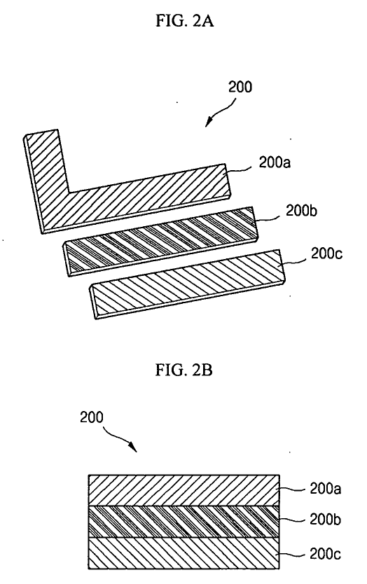

FIG. 2A is an exploded perspective view of the connection lead of the pouch type lithium rechargeable battery according to an exemplary embodiment of the present invention. FIG. 2B is a sectional view of the connection lead of the pouch type lithium rechargeable battery according to an exemplary embodiment of the present invention.

Referring to FIG. 2A and FIG. 2B, the connection lead 200 of the pouch type lithium rechargeable battery functions as a positive thermal coefficient device.

The connection lead 200 includes an upper conductive plate 200a, a lower conductive plate 200c, and a positive thermal coefficient layer 200b interposed between the upper conductive plate 200s and the lower conductive plate 200c.

One of the upper conductive plate 200a and the lower conductive plate 200c is coupled with one of the protective circuit module 130 and the first electrode tab 114 and the second electrode tab 115 of the pouch type lithium rechargeable battery 100. For example, the upper conductive plate 200a may be coupled with the protective circuit module 130 and the lower conductive plate 200c may be coupled with the second electrode tab 115 serving as a negative electrode tab.

At least one of the upper conductive plate 200a and the lower conductive plate 200c that is coupled with the protective circuit module 130 may have an L-shape. However, the present invention does not limit the shape of the upper conductive plate 200a and the lower conductive plate 200c. In addition, the upper conductive plate 200a and the lower conductive plate 200c may comprise Ni, Ni alloys or equivalents thereof, but is not limited thereto.

The positive thermal coefficient layer 200b may comprise polymer compositions. For example, the positive thermal coefficient layer 200b may include styrene butadiene rubber (SBR) and carbon distributed in the SBR. The positive thermal coefficient layer 200b may be less than about 0.3 mm thick. If the positive thermal coefficient layer 200b exceeds 0.3 mm thick, the height of the protective circuit module 130 increases when it is positioned above the exposed parts of the first electrode tab 114 and the second electrode tab 115 on the bonding part 123 of the pouch case 120. In this case, a pouch type lithium rechargeable battery 100 cannot be stably accommodated in the hard case to form a hard battery pack.

According to the pouch type lithium rechargeable battery 100 of the present invention, the connection leads 140, 145 and 200 couple the electrode assembly 100 with the protective circuit module 130 and may act at positive thermal coefficient devices. As opposed to conventional positive thermal coefficient devices, the positive thermal coefficient devices of the present invention function as the connection leads so that heat generated from the electrode assembly is directly applied to the positive thermal coefficient devices, thereby improving the reaction speed and reliability of the positive thermal coefficient devices. In addition, since the reaction speed of the positive thermal coefficient devices can be improved, dangerous explosions of the pouch type lithium rechargeable battery 100 may be avoided.

Since the connection leads 140, 145 and 200 function as the positive thermal coefficient devices, the circuits of the pouch type lithium rechargeable battery 100 can be shut off within a short time when the internal temperature of the pouch type lithium rechargeable battery 100 rises abnormally. Thus, stability of the pouch type lithium rechargeable battery 100 may be improved and the battery pack having the pouch type lithium rechargeable battery 100 has a lower risk of a dangerous explosion.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A pouch type battery, comprising:
an electrode assembly including a first electrode plate, a second electrode plate, and a separator interposed between the first electrode plate and the second electrode plate;
a pouch case including a cavity for accommodating the electrode assembly therein;
a protective circuit module; and
a connection lead that couples the protective circuit module with the electrode assembly while shutting off a current in the pouch type lithium rechargeable battery when a temperature of the pouch type lithium rechargeable battery rises abnormally.

2. The pouch type battery of claim 1,
wherein the connection lead includes an upper conductive plate, a lower conductive plate, and a positive thermal coefficient layer interposed between the upper conductive plate and the lower conductive plate.

3. The pouch type battery of claim 2,
wherein one of the upper conductive plate and the lower conductive plate is coupled with the electrode assembly and another one of the upper conductive plate and the lower conductive plate is coupled with the protective circuit module.

4. The pouch type battery of claim 2,
wherein at least one of the upper conductive plate and lower conductive plates has an L-shape.

5. The pouch type battery of claim 2,
wherein the upper conductive plate and the lower conductive plate comprise Ni.

6. The pouch type battery of claim 2,
wherein the positive thermal coefficient layer is less than about 0.3 mm thick.

7. The pouch type battery of claim 2,
wherein the positive thermal coefficient layer comprises styrene butadiene rubber (SBR) and carbon distributed in the SBR.

8. A pouch type battery, comprising:
an electrode assembly including a first electrode plate, a second electrode plate, and a separator interposed between the first electrode plate and the second electrode plate;
a pouch case including a cavity for accommodating the electrode assembly therein;
a protective circuit module; and
a connection lead that couples the protective circuit module with the electrode assembly and functions as a positive thermal coefficient device.

9. The pouch type battery of claim 8,
wherein the connection lead includes an upper conductive plate that is coupled with the electrode assembly, a lower conductive plate that is coupled with the protective circuit module, and a positive thermal coefficient layer that is interposed between the upper conductive plate and the lower conductive plate.

10. The pouch type battery of claim 8,
wherein the positive thermal coefficient layer is less than about 0.3 mm thick.
